(19) United States
(12) Patent Application Publication
(10) Pub. No.: US 2025/0214100 A1
(43) Pub. Date: Jul. 3, 2025

(54) NEBULIZING DEVICE

(71) Applicant: DONGGUAN YIH TEH ELECTRIC PRODUCTS CO., LTD., DongGuan City (CN)

(72) Inventor: Ming Jen Hsiao, Miaoli County (TW)

(21) Appl. No.: 18/402,376

(22) Filed: Jan. 2, 2024

(51) Int. Cl. B05B 15/52; B05B 1/10; B05B 1/30; B05B 7/24; B05B 7/26; B05B 15/65

(52) U.S. Cl. CPC B05B 15/52; B05B 7/2491; B05B 7/265; B05B 15/65; B05B 1/10; B05B 1/30

(57) ABSTRACT

A nebulizing device comprising a nebulizing room, a gas providing device, a spray head; the nebulizing room comprising a cavity and the side of the nozzle of the spray head accommodated inside of the cavity, the other side of the spray head extending to the outside and connecting with the gas providing device, a coupling section below the cavity, a tube is inside the coupling section; a suction mouth at one side of the tube extending upward inside the cavity, and the suction mouth is proximate to the nozzle, the coupling section connecting with a bottle filled with scented liquid, the other side of the tube extending inside the scented liquid, the gas providing device producing air and ejecting high-speed airflow from the nozzle that passing through the above of the suction mouth and forming negative pressure, thereby drawing scented liquid from the bottle to the suction mouth to overflow; the nozzle providing high-speed airflow to blow scented liquid that overflows from the suction mouth into vapor to the outside; the nebulizing device can moderately release scented liquid from the bottle and atomize scented liquid effectively.

### BACKGROUND OF THE INVENTION

### 1. Field of the Invention

The present invention relates to a nebulizing device, and more particularly to use a bottle containing liquid and atomizing liquid into vapor by using the nebulizing device.

### 2. Description of the Related Art

Current nebulizing devices include scent and liquid nebulizing devices such as essential oil diffuser devices of previous US Pat. No. US20190275186-A1, US20190307913-A1 and U.S. Pat. No. 11,000,618. The structures of said devices are more complex, the volume of said devices is greater and the exhaustion of essential oil is more rapid which leads to inefficient control of the consumption of essential oil. In addition, essential oil in the bottle will be drawn to the outlet of a tube and overflow to form essential oil droplets. Airflow from the nozzle atomizes the droplets and the adhesive substance of essential oil droplets blocks the outlet of the tube of devices, which said devices cannot efficiently provide scented liquid at the outlet of the tube therefore the atomizing effectiveness will be affected.

### SUMMARY OF THE INVENTION

A nebulizing device disclosed herein can moderately release the amount of scented liquid being used from a bottle containing scented liquid, and the nebulizing device can efficiently atomize the scented liquid. The nebulizing device can at least resolve or overcome the problem of exhausting rapid and considerable usage of scented liquid.

A nebulizing device with a bottle containing scented liquid disclosed herein, wherein the scented liquid is drawn to the outlet of a tube and may form an adhesive substance of the scented liquid blocking the outlet of the tube 77 and can be removed and cleaned to avoid blocking the outlet of the tube 77 to maintain the outstanding atomizing result of the nebulizing device.

In some embodiments of the present invention, the nebulizing device comprising: a body, a power connected unit, a gas providing device, an atomizer room; The body comprising an accommodation chamber, an opening, and the accommodation chamber defined in the body, and the opening accommodated on the upper of the accommodation chamber; the power connected unit, the gas providing device and the atomizer room housed in the accommodation chamber; the gas providing device comprising an air inflow segment and an air outflow segment and the gas providing device electrically connected with the power connected unit; the atomizer room comprising a cavity, a coupling section, a lid, a spray head, a tube;
The cavity defined in the atomizer room, and the coupling section accommodated at the bottom of the cavity. The top of the lid has an atomized orifice, and the lid is arranged on top of the cavity;
The free end of the spray head forms a nozzle, wherein the side of the nozzle of the spray head accommodated inside of the cavity. The other side of the spray head extending to the outside and connecting with the air inflow segment of the gas providing device.

The tube is inside the coupling section and the free end of the tube forms a suction mouth extending toward the cavity. The suction mouth is proximate to the nozzle. The nozzle has a minimum effective diameter therethrough discharging the center of the airflow axis that passes through the above of the outlet of the suction mouth.

The cross-sectional portion of the spray head that extending toward the side of the nozzle forming a first shrinkage conduit, and the narrowest free end of the first shrinkage conduit forming the nozzle. The cross-sectional portion of the tube that extending towards the side of the suction mouth formed a second shrinkage conduit, and the narrowest free end of the second shrinkage conduit formed the suction mouth.

In some embodiments of the present invention, the nebulizing device further comprising a bottle containing liquids, wherein said coupling section connecting with the bottle, and the bottle containing liquids comprising scents, liquids or alcohol and so on. The other side of the tube can extend toward the inside of the liquids of the bottle.

The power connected unit electrically couples with power, the power supplying the gas providing device producing high-pressure airflow passing through the shrunk cross-sectional portion of the first shrinkage conduit, and forming high-speed airflow from the nozzle of the spray head to pass through the above of the suction mouth of the tube to form an area of negative air pressure (such as Bernoulli's principle), therefore the scented liquid (e.g. fragrance oil, essential oil) inside the bottle are being drawn through the second shrinkage conduit to the suction mouth to overflowing continual certain volume of droplets of scented liquid successively to control minimally overflowing the scented liquid. The nozzle provides continual high-speed airflow which blows scented liquid into vapor. The vapor accumulates in the cavity of the atomizer room, and fragrance will spread from the atomized orifice of the lid to the outside.

In some embodiments of the present invention, the certain caliber of the suction mouth overflowing certain volume of scented liquid, and the volume of the droplet particles includes, for example, approximately 10 to 1,000 μm3 to release a moderate amount of scented liquid usage. Furthermore, the caliber of the conical end of the suction mouth and the second shrinkage conduit can determine the size of the caliber of the tube outlet inside the liquids of the bottle, thereby the high-speed airflow of the nozzle can atomize scented liquid efficiently to at least resolve the exhaustion and substantial usage of scented liquid and to extend the scent diffusing time of the nebulizing device.

In some embodiments of the present invention, the nebulizing device further comprising a printed circuit board, an upper case; the printed circuit board comprising a converter circuit, and the power connected unit electrically couples with the gas providing device and the printed circuit board; the upper case comprising an electrical circuit touch device, and the electrical circuit touch device movably electrically connecting with the printed circuit board and the converter circuit, thereby opening and closing the function of the printed circuit board, or opening and closing the function of the converter circuit electrically coupling with the gas providing device. Thus, raising the voltage of power to the gas providing device (such as raising 5V to 7V or 10V). The gas providing device can produce and deliver greater air pressure to the spray head when following instructions, and ejecting greater high-speed airflow to eliminate adhesive substance at the outlet of the suction mouth formed by scented liquid or essential oil in a short time and to achieve the cleansing of the suction mouth of the nebulizing device to avoid adhesive substance of the scented liquid (e.g. essential oil or fragrance oil) blocking the outlet of the suction mouth.

In the embodiments of the present invention, the coupling section is further connected to a bottle comprising alcohol. The alcohol inside the bottle is drawn into the suction mouth through the tube. Alcohol can further break down and melt the adhesive substance of scented liquid (e.g. fragrance oil) that blocks the outlet of the suction mouth, therefore said high-speed airflow can eliminate the adhesive substance of scented liquid (e.g. fragrance oil or colloid) more easily to meet the cleansing function of the present invention to avoid the adhesive substance of the scented liquid (e.g. fragrance oil) blocking the outlet of the outlet of the suction mouth.

Comparing with prior technique, the nebulizing device of the present invention providing a nebulizing device moderately release fragrance oil to promote effective evaporation, thereby saving fragrance oil and extending the use of time of the benefit of scented liquid of the nebulizing device through the design of the present invention comprising a selective cleansing function that can raise the amount and speed rate of the airflow of the nozzle through control in any time to eliminate the adhesive substance of the scented liquid (e.g. fragrance oil) at the outlet of the tube located inside the atomizer room of the present invention, this design can avoid scented liquid from blocking the outlet of the tube to maintain outstanding atomizing result of scented liquid.

### BRIEF DESCRIPTION OF THE DRAWINGS

FIG. 1 is a perspective view showing the assembly nebulizing device according to an embodiment of the present invention.

FIG. 2 is another perspective view showing the assembly nebulizing device according to an embodiment of the present invention.

FIG. 3 is an exploded view showing the exploded components of the nebulizing device according to an embodiment of the present invention.

FIG. 4 is a top view of the nebulizing device according to an embodiment of the present invention.

FIG. 5 illustrates a cross-sectional view along the line C-C in FIG. 4

FIG. 6 illustrates a cross-sectional view along the line A-A in FIG. 4

FIG. 7 illustrates a cross-sectional view along the line B-B in FIG. 4

### DETAILED DESCRIPTION OF THE PREFERRED EMBODIMENT

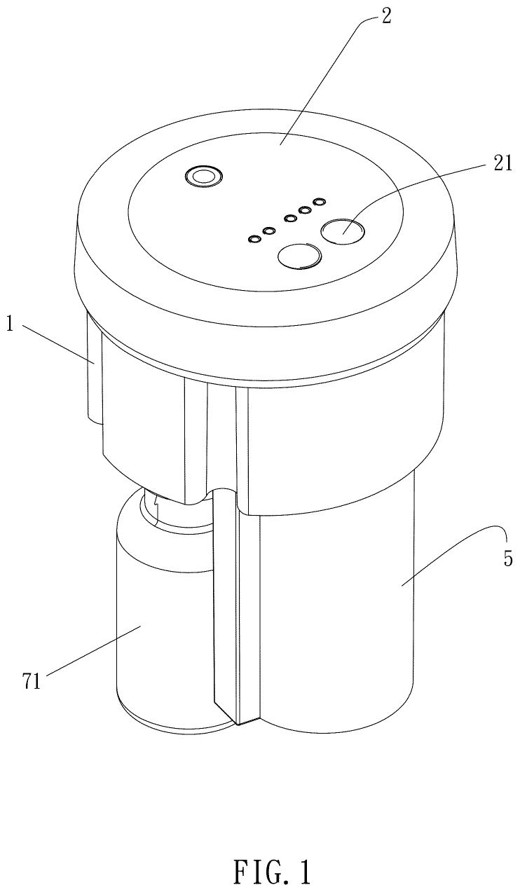

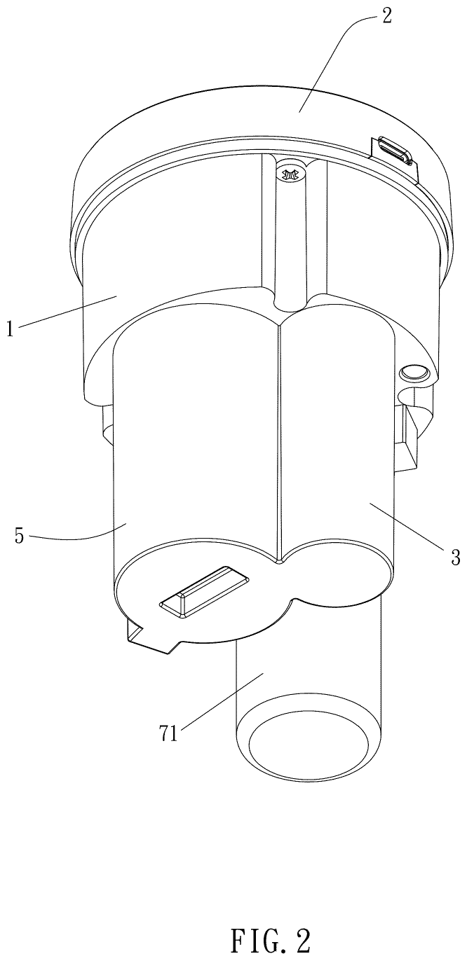

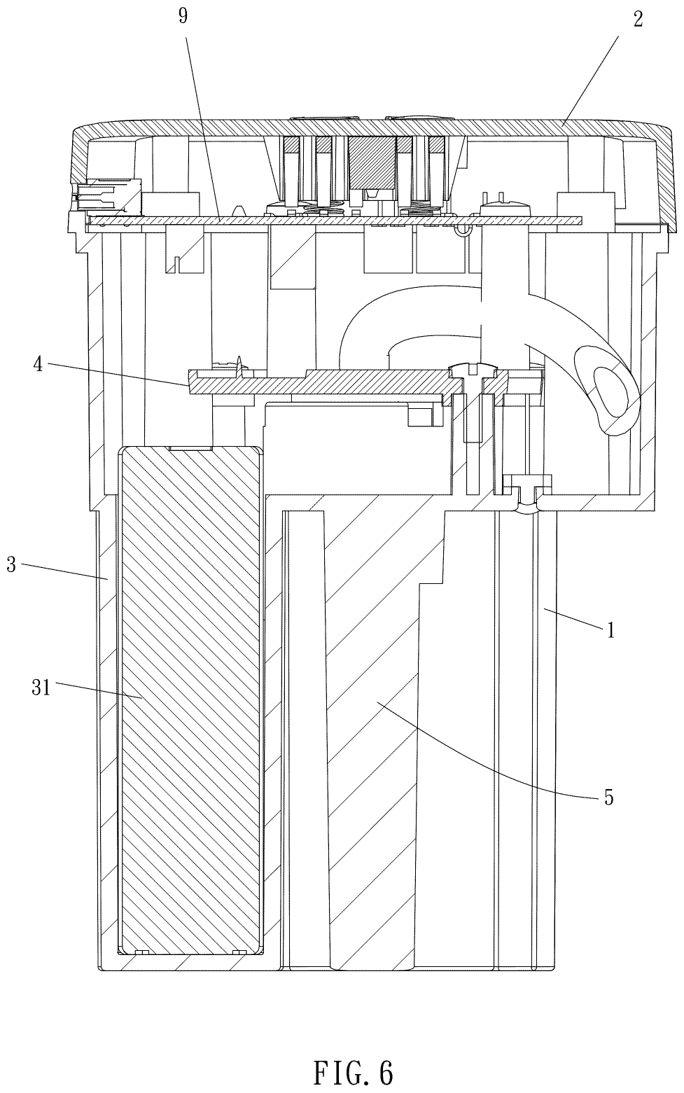

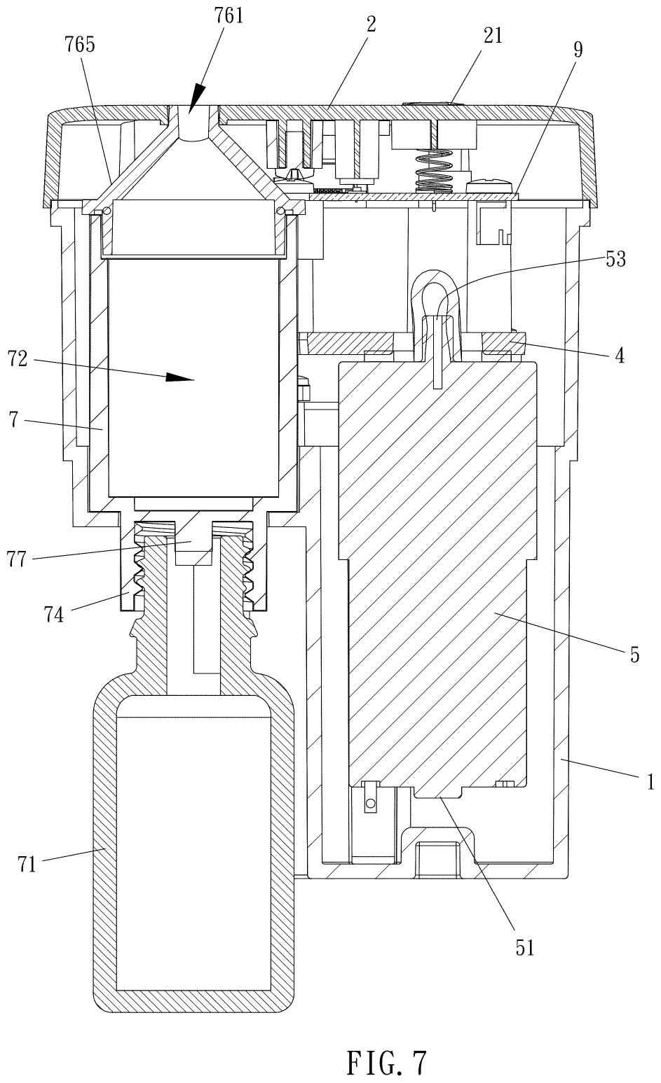

With reference to FIGS. 1 to 7, in some embodiments of the present invention, the nebulizing device comprises: a body 1, a power connected unit 3, a gas providing device 5, an atomizer room 7. The body 1 comprising an accommodation chamber 11, an opening 13, and the accommodation chamber 11 defined in the body 1, and the opening 13 accommodated on the upper of the accommodation chamber 11; the power connected unit 3, the gas providing device 5 and the atomizer room 7 housed in the accommodation chamber 11;

The body 1 and the accommodation chamber 11 in the figures of the embodiment integrated with the power connected unit 3, the gas providing device 5 and the atomizer room 7; the gas providing device 5 comprising an air inflow segment 51 and an air outflow segment 53 and the gas providing device 5 electrically connected with the power connected unit 3; the atomizer room 7 comprising a cavity 72, a coupling section 74, a lid 76, a spray head 75, a tube 77; the cavity 72 defined in the atomizer room 7, and the coupling section 74 is formed at the bottom of the cavity 72, the top of the lid 76 has an atomized orifice 761, and the lid 76 is arranged on top of the cavity 72; the free end of the spray head 75 formed a nozzle 755, the side of the nozzle 755 of the spray head 75 accommodated inside of the cavity 72, the other side of the spray head 75 extends to the outside and connects with the air inflow segment 53 of the gas providing device 5; in some embodiments of the present invention, the other side of the nozzle 75 can use a conduit to connect the gas providing device 5; the tube 77 is inside the coupling section 74 and the free end of the tube 77 forms a suction mouth 771 extending toward the cavity. The suction mouth 771 is proximate to the nozzle 755; The cross-sectional portion of the spray head 75 that extending toward the side of the nozzle 755 forming a first shrinkage conduit 751, and the narrowest free end of the first shrinkage conduit 751 formed the nozzle 755 with cone-shaped; the cross-sectional portion of the tube 77 that extending towards the side of the suction mouth formed a second shrinkage conduit 775, and the narrowest free end of the second shrinkage conduit 775 formed the suction mouth 771 with cone-shaped. In some embodiments of the present invention, the suction mouth 771 is proximate to the nozzle 755; the meaning of the term “proximate” includes “close” “is closely proximate to” and “is extremely proximate to” and therefore the meaning of “proximate” cannot be construed as limiting.

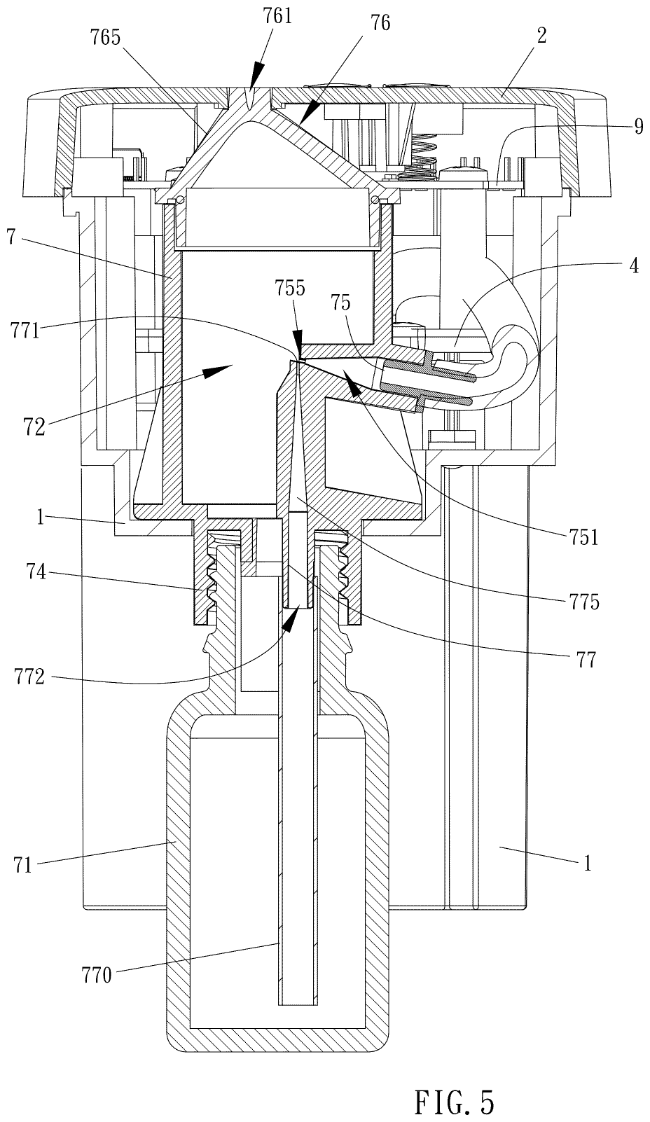

With reference to FIGS. 1, 4, 5 and 7, in some embodiments of the present invention, the coupling section 74 can couple with a bottle 71 containing liquids (e.g. scented liquid, alcohol), the tube outlet 772 of the tube 77 can extend inside the bottle 71. In the embodiment shown in figures, the length of the tube 77 is not limited to figures of the embodiment, the length of the tube 77 can extend toward a distance, thereby extending to scented liquid inside bottle 71. In the embodiment shown in figures, the tube outlet 772 of the tube 77 can join with one side of a connecting duct 770 shown in FIG. 5 to extend the length of the tube 77, and the other side of the connecting duct 770 can extend scented liquid inside the bottle 71.

The power connected unit electrically couple with power, the power, for example, a battery 31 providing an alternating current to the gas providing device 5 to produce high pressure airflow that flows through the nozzle 755 of the spray head 75 and passes through the above of the suction mouth 771 of the tube 77 to form an area of negative pressure (such as Bernoulli's principle), therefore the scented liquid (e.g. fragrance oil, essential oil) inside the bottle are being drawn to suction mouth 771 and overflow continual small droplets. The nozzle 755 providing continual high-speed airflow, which blows scented liquid from suction mouth 771 into a vapor of scented liquid. The vapor accumulates in the cavity 72 of the atomizer room 7, and vapor of scent (e.g. fragrance) will spread from the atomized orifice 761 of the lid 76 to the outside.

In some embodiments of the present invention of the nebulizing device, continual high-speed airflow passes through the differential current pressure produced by the surroundings of the suction mouth 771 (atmospheric pressure) is negative pressure), the differential airflow pressure from the suction mouth 771 brings fluid to an external suction into the tube 77 and drawn scented liquid from bottle 71 to suction mouth 771 to overflow continual small scented droplets. The nozzle 755 providing continual high-speed airflow, which blows scented liquid from the suction mouth into vapor, and this phenomenon is Bernoulli's principle that gas providing device 5 delivers continual high-pressure airflow that passes through the first shrinkage conduit 751 of the spray head 75 that causes bumping airflow to flow at the narrowest portion of the spray head 75, and the speed reaches to the maximum at the nozzle 755. The air pressure from the gas providing device 71 (e.g. air pump or fan) rises because when airflow passes the small diameter portion causes the small diameter to shrink, and all the airflow passes the first shrinkage conduit 751 at the same time when the small diameter tapers, thereby air pressure decreases at the same time. When delivering continual high-speed airflow via nozzle 755 through above of suction mouth 75 via nozzle 755, the high-speed airflow around the surroundings of the suction mouth 771 produces atmospheric pressure, thereby producing a drawing effect at the suction mouth 771.

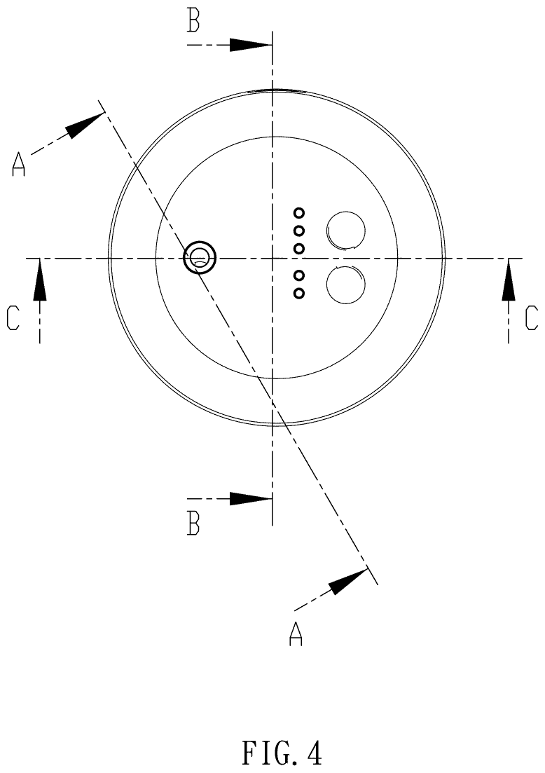

With reference to FIGS. 4 and 5, in some embodiments of the present invention, the tube outlet 772 of tube 77 inside the scented liquid of bottle 71. The setting of the diameter of the tube is greater than suction mouth 771 such as the diameter is several times to dozens of times greater. Furthermore, the caliber of the end of conical shape's (cone) suction mouth 771 can determine the size of the caliber of the tube outlet 772 of the tube. Correspondingly, the second shrinkage conduit 775 forming a tapered slit of the caliber of the tube that low gradient of the contraction rate and forming a micro caliber of the suction mouth 771 at the narrowest end, thereby controlling the overflow of certain volume of scented liquid such as essential droplets.

In some embodiments of the present invention, the volume of scented liquid particles includes 10 μm³ to 1000 μm³; in some embodiments of the present invention, wherein the suction mouth is for overflowing scents or liquids 50 μm³ to 500 μm³ thereby controlling a moderate amount of usage of scented liquid (such as essential oil) to atomize effectively by the high-speed airflow from nozzle 755 to at least resolve the problem of the exhaustion of scented liquid is more rapid and substantial usage of scented liquid. The control of the size of the scented liquid particles can save the usage of scented liquid and increase the usage time to allow the diffusing of scent (e.g. fragrance) last longer.

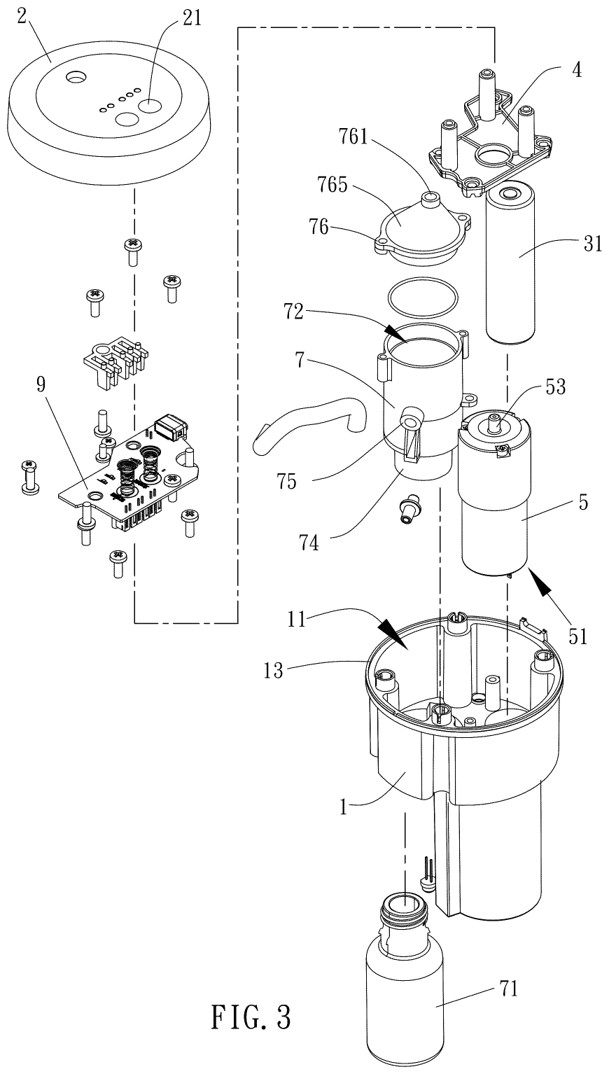

With reference to FIGS. 3 to 5 and 7, in some embodiments of the present invention, wherein the nozzle 755 of the spray head 75 is slightly higher than the position of the suction mouth 771 of the tube 77. The outlet of the nozzle 755 is set near the upper side of the suction mouth 771. The nozzle 755 ejecting airflow from the gas providing device 5 (e.g. air pump) to an area above suction mouth 771 and forming a negative pressure area, thereby drawing scented liquid droplets to allow high-speed airflow from nozzle 755 to atomize the scented liquid droplets, and forming scent vapor to accumulate pressure inside the lid 76. Thus, the scent vapor airflow with outstanding effectiveness was forced to pass through the atomized orifice 761.

With reference to FIGS. 4 and 5, in some embodiments of the present invention, wherein the suction mouth 771 is proximate to the air central axis of the outlet of the nozzle 755, the nozzle having a minimum effective diameter therethrough discharging the center of the airflow axis that passes through the above of the outlet of the suction mouth. The distance between suction mouth 771 and nozzle 755 is extremely close. For example, the distance in between is 0.05 mm to 0.3 mm. The air central axis of the outlet of the nozzle 755 delivers a bundle of airflow that can correctly be directed to and pass through the above middle of the outlet of the suction mouth 771, and forms a low-pressure area at the suction mouth 771 (such as the negative pressure area that is lower than atmospheric pressure). In other words, the bottle 71 with atmospheric pressure that can effectively drive scented liquid to atomize.

With reference to FIGS. 4 and 5, in some embodiments of the present invention, wherein the nozzle 755 is proximate to the top of the suction mouth vertically and therethrough discharging the airflow bundle central axis that passes vertically through the above of the middle of the suction mouth 771. In the figures, the relative position and angle of the nozzle 755 and the suction mouth 771 are for reference and should not be limited to the relative position or angle of the nozzle 755 and the suction mouth 771.

With reference to FIGS. 3 to 5, in some embodiments of the present invention, wherein the nebulizing device is designed as a small portable diffuser, the cavity 72 has a rather small room, the outlet axis of nozzle 755 is vertically set at the suction mouth 771. The mixed airflow containing the scented liquid and air from the nozzle, is blocked by the inner wall of the cavity 72 and may affect the speed rate of airflow and the atomization of liquids. Thus, the outlet axis of the nozzle 755 and the outlet axis of the suction mouth 771 forms an angle less than 90 degrees. When nozzle 755 ejects high-speed airflow, the airflow can cover the upper area of the suction mouth 771 to form an area of negative pressure, and at the same time, the overflowing liquid droplets from suction mouth 771 to form an acute angle with airflow of the nozzle 755 drive scented liquid from suction mouth 771 to overflow easily and not to block suction mouth 771, and furthermore smoothly directs atomized scented liquid to the area of the atomized orifice 761. By comparison, atomized airflow will not be blocked by the inner wall of atomized room 7. In the figures, the relative position of the nozzle 755 and the suction mouth 771 is for reference and should not be limited to the relative position or angle of the nozzle 755 and the suction mouth 771.

In some embodiments of the present invention, wherein the direction of the outlet axis of the nozzle 755 and the suction mouth forms an angle comprising 89 to 45 degrees. The airflow of the nozzle 755 and suction mouth 771 overflowing liquid droplets that form an acute angle, and the suction mouth 771 overflows more smoothly and not easily block suction mouth 771. In some embodiments, the outlet axis of the nozzle 755 and the suction mouth 771 forms an acute angle comprising 88 to 75 degrees, the output airflow of nozzle 755 still maintain outstanding pressure drop at suction mouth 771.

With reference to FIGS. 3 to 5 and 7, in some embodiments of the present invention, wherein the lid 76 including a third shrinkage conduit 765 and the cross-sectional portion of the lid 76 points to the side of the atomized orifice 761 to form the third shrinkage conduit 765; The narrowest portion of the third shrinkage conduit 765 forms the atomized orifice 761. In some embodiments of the present invention, wherein the nebulizing device and the atomizer room 7 have a smaller space and to save the amount of essential oil, the suction mouth 771 overflows little droplets; thus, the atomized scents are small in amount, and therefore the atomizer room 7 of the lid 76 forms the third shrinkage conduit 765 to allow scents to accumulate at the atomized orifice 761 and being forced to release to the outside.

With reference to FIGS. 1 to 3 and 7, in some embodiments of the present invention, wherein the gas providing device comprising an air pump or a fan. In the figures of the embodiments, thereby directing high pressure airflow from the air pump to the second shrinkage conduit 775 of spray head 75 and producing high-speed airflow from nozzle 755.

With reference to FIGS. 3 to 5, in some embodiments of the present invention, wherein the spray head 75 and the tube 77 are integrated as one, and the center of the airflow axis of the nozzle 755 can meticulously pass through the above of the suction mouth 771. In some embodiments of the present invention, the angle of the airflow axis of the nozzle 755 and the suction mouth 771 can meticulously form an angle of less than 90 degrees to stably form an area of negative pressure above of the suction mouth 771 (such as Bernoulli's principle).

With reference to FIGS. 1 to 5, in some embodiments of the present invention, wherein the nebulizing device further comprising a bottle 71 containing liquids, and within bottle 71 containing liquids not limited to any of the scented liquid, alcohol, or detergent. The scented liquids such as fragrance liquids, fragrance oil, essential oil, flower essence or different scented liquid. The bottle 71 including any of the fragrance liquid bottles, essential oil bottles, fragrance oil bottles, flower essence bottles, liquid essence bottles, detergent bottles or alcohol bottles. The bottle 71 is configured to removably connect with the coupling section 74. The tube outlet 772 of the tube 77 can extend into scented liquid inside of the bottle 71.

In the embodiment of the present invention shown in FIG. 5, the length of the tube 77 is not limited to figures of the embodiments the length of the tube 77 can extend toward a distance, thereby extending the tube 77 to scented liquid inside bottle 71. In some embodiments of the present invention, the other side of the tube 77 can join with one side of a connecting duct 770 shown in FIG. 5 to extend the length of the tube 77, and the other side of the connecting duct 770 can extend into the scented liquid inside the bottle 71.

In some embodiments, the coupling section 74 connecting with the bottle 71 including screw threads apparatus, fastener, magnetic apparatus, clip apparatus, hook apparatus, or absorption apparatus. The bottle 71 connects with the apparatuses and can configure to removably connect with the coupling section. In the embodiment shown in figures, the coupling section 74 connects with bottle 71 through the screw threads apparatus.

With reference to FIGS. 1 to 7, in some embodiments of the present invention, wherein the nebulizing device further comprising a printed circuit board 9, an upper case; the printed circuit board comprises a converter circuit; the printed circuit board 9 and the power connected unit 3 electrically couple with the gas providing device 5. The upper case 2 comprising an electrical circuit touch device 21, and the electrical circuit touch device 21 movably electrically connects with the printed circuit board 9 and the converter circuit, thereby opening and closing the function of the printed circuit board, or opening and closing the function of the converter circuit electrically coupling with the gas providing device. Thus, raising the voltage of power to the gas providing device, such as raising 5V to 7V or 10V or 12V, the real voltage should be designed by the requirement, and the above embodiments should not be limited to the voltage of the converter circuit of the printed circuit board. Accordingly, the gas providing device 5 can produce and deliver greater air pressure to the spray head 75 with instructions, and eject greater high-speed airflow to eliminate adhesive substance of scented liquid (e.g. essential oil) formed at the suction mouth 771 in a short time and to achieve the cleansing function of the nebulizing device to avoid adhesive scented liquid (e.g. essential oil or fragrance oil) blocking the outlet of the suction mouth 771.

The nebulizing device wherein comprising a bracket 4, and the bracket 4 comprising the bottom of the bracket 4 connects with the inner side of the body 1 and the upper side of the bracket 4 connects with the printed circuit board 9; The printed circuit board 9 electrically connects with the electrical circuit touch device 21 from the upper case 2.

With reference to FIGS. 1, 2 and 7, in some embodiments of the present invention, wherein the coupling section 74 is further connected to a bottle 71 containing liquids, the liquid such as alcohol. Accordingly, the alcohol inside the bottle is drawn into the suction mouth 771 through the tube 77. Alcohol droplets can further break down and melt the adhesive scented liquid (e.g. essential oil or fragrance oil) that blocks the suction mouth 771, therefore said high-speed airflow from nozzle 755 can eliminate adhesive substance of essential oil more easily to achieve the cleansing function of the nebulizing device to avoid the adhesive substance of essential oil blocking the suction mouth 771.

The nebulizing device moderately releases and effectively atomizes essential oil or scented liquid to meet the benefit of saving essential oil. The adhesive substance of scented liquid at the suction mouth 771 of the tube 77 inside the atomizing room 7 of the nebulizing device can selectively use the cleansing function through the design of the nebulizing device 100 of the present invention to increase the amount and speed rate of airflow through the nozzle 755 in any time by control or combine with alcohol to eliminate adhesive substance of the scented liquid from the suction mouth 771 of the nebulizing device and avoid adhesive substance from blocking the suction mouth 771 of the tube 71; therefore, maintaining an outstanding atomizing effect and extending diffusing time of scented liquid.

The above embodiments of the present invention, the nebulizing device are only to clearly state the examples in the present invention rather than limiting the embodiments of the present invention. For a person having ordinary skill in the art, based on the above statement, the embodiments can modify and change into different forms and should not further provide examples of all the embodiments. Any changes, shifts and progression according to the essence and the principle of the present invention should be included in the claims under the protection of the present invention.

What the invention claimed is:

1. A nebulizing device comprising:
a body, a power connected unit, a gas providing device, an atomizer room;
the body comprising an accommodation chamber, an opening, and the accommodation chamber defined in the body, and the opening accommodated on the upper of the accommodation chamber;
the power connected unit, the gas providing device and the atomizer room housed in the accommodation chamber;
the gas providing device comprising an air inflow segment and an air outflow segment and the gas providing device electrically connected with the power connected unit;
the atomizer room comprising a cavity, a coupling section, a lid, a spray head, a tube;
the cavity defined in the atomizer room, and the coupling section is formed at the bottom of the cavity, the top of the lid has an atomized orifice, and the lid is arranged on top of the cavity;
the free end of the spray head formed a nozzle, wherein the side of the nozzle of the spray head accommodated inside the cavity, the other side of the spray head extends to the outside and connects with the air inflow segment of the gas providing device;
the tube is inside the coupling section, the free end of the tube formed a suction mouth in the cavity; The suction mouth is proximate to the nozzle;
the cross-sectional portion of the spray head that extending toward the side of the nozzle forming a first shrinkage conduit, and the narrowest free end of the first shrinkage conduit formed the nozzle; The cross-sectional portion of the tube that extending towards the side of the suction mouth formed a second shrinkage conduit 751, and the narrowest free end of the second shrinkage conduit 751 formed the suction mouth.

2. The nebulizing device as claimed in claim 1, wherein the nozzle having a minimum effective diameter therethrough discharging the center of the air flow axis that passes through the above of the outlet of the suction mouth.

3. The nebulizing device as claimed in claim 1, wherein the position of the nozzle of the spray head is higher than the position of the suction mouth of the tube.

4. The nebulizing device as claimed in claim 1, wherein the suction mouth is proximate to the air central axis of the outlet of the nozzle.

5. The nebulizing device as claimed in claim 1, wherein the nozzle is proximate to the top of the suction mouth vertically and therethrough discharging the airflow bundle central axis that passes through the above of the suction mouth vertically.

6. The nebulizing device as claimed in claim 1, wherein the outlet axis of the nozzle and the outlet axis of the suction mouth are an angle less than 90 degree.

7. The nebulizing device as claimed in claim 6, wherein the outlet axis of the nozzle and the outlet axis of the suction mouth comprising an angle between 89 to 45 degrees.

8. The nebulizing device as claimed in claim 7, wherein the outlet axis of the nozzle and the outlet axis of the suction mouth including an angle between 88 to 75 degrees.

9. The nebulizing device as claimed in claim 1, wherein the lid including a third shrinkage conduit and the cross-sectional portion of the lid points to one side of the atomized orifice to form the third shrinkage conduit; The narrowest portion of the third shrinkage conduit forms the atomized orifice.

10. The nebulizing device as claimed in claim 1, wherein the gas providing device is either air pump or fan.

11. The nebulizing device as claimed in claim 1, wherein the spray head and the tube are integrated as one.

12. The nebulizing device as claimed in claim 1, wherein the nebulizing device further comprising a bottle containing liquids; The bottle including but not limited to any of the bottle containing scents, the bottle containing essential oil, the bottle containing fragrance essential oil, the bottle containing flower essential oil, the bottle containing fragrance oil, the bottle containing detergent or the bottle containing alcohol; the bottle configured to removably connect with the coupling section.

13. The nebulizing device as claimed in claim 12, wherein the nebulizing device further comprises a printed circuit board, an upper case; the printed circuit board comprises a converter circuit; The printed circuit board and the power connected unit electrically couple with the gas providing device; The upper case comprises an electrical circuit touch device, and the electrical circuit touch device movably electrically connects with the printed circuit board and the converter circuit.

14. The nebulizing device as claimed in claim 12, wherein the suction mouth is for overflowing scents or liquids 10 μm³ to 1000 μm³.

15. The nebulizing device as claimed in claim 14, wherein the suction mouth is for overflowing scents or liquids 50 μm³ to 500 μm³.

16. The nebulizing device as claimed in claim 1, wherein the nebulizing device further comprises a printed circuit board, an upper case; the printed circuit board includes a converter circuit; The printed circuit board and the power connected unit electrically couple with the gas providing device; The upper case includes an electrical circuit touch device, and the electrical circuit touch device movably electrically connects with the printed circuit board and the converter circuit.

17. The nebulizing device as claimed in claim 16, wherein the nebulizing device comprises a bracket, and the bottom of the bracket connects with the inner side of the body and the top of the bracket connects with the printed circuit board; The printed circuit board electrically connects with the electrical circuit touch device from the upper case.
